(19) United States
(12) Patent Application Publication
(10) Pub. No.: US 2012/0166982 A1
(43) Pub. Date: Jun. 28, 2012

(54) CODE LIST CACHE FOR VALUE HELP

(76) Inventors: UDO KLEIN, Maximiliansau (DE); THOMAS GAUWEILER, Speyer (DE)

(21) Appl. No.: 12/979,235

(22) Filed: Dec. 27, 2010

(51) Int. Cl. G06F 3/048

(52) U.S. Cl. 715/764

(57) ABSTRACT

Methods and apparatus, including computer program products, are provided for providing value help. In one aspect, there is provided a computer-implemented method. The method may include receiving, at a code list provider, a request from a user interface for code list value help; accessing, by the code list provider, a cache including at least one code list, the cache implemented in memory; and sending, by the code list provider, the at least one code list accessed from cache to a user interface to enable the user interface to provide code list value help based on at least one code list. Related apparatus, systems, methods, and articles are also described.

### FIELD

The present disclosure generally relates to providing value help including a code list to a user interface.

### BACKGROUND

When a user at a user interface accesses an application at a server, the user may input one or more values at the user interface. However, if the user needs assistance, the user may obtain “value help.” For example, the user may move an indicator over an element and a value help function may provide value help, i.e., help information for the element at the user interface. A classic example is in the case of a flight reservation system, the user may select a destination city and the value help may provide, autonomously, or at the request of a user (e.g., selecting function F4), a value help list of all possible destination cities. Specifically, as a user types in the letter D in an input for the destination city, a list of cites, such as Denver, Detroit, Dansville, is provided as a value help drop down list. If the user enters a second value “a,” the list may be filtered to all cities starting with “DA,” and so forth as additional values are input. If a user selects a city in the drop down list, the selected city from the drop down list becomes the input at the user interface. Thus, value assists the user performing tasks via the user interface.

### SUMMARY

In one aspect, there is provided a computer-implemented method. The method may include receiving, at a code list provider, a request from a user interface for code list value help; accessing, by the code list provider, a cache including at least one code list, the cache implemented in memory; and sending, by the code list provider, the at least one code list accessed from cache to a user interface to enable the user interface to provide code list value help based on at least one code list.

In some implementations, one of more variations may be made as well as described in the detailed description below and/or as described in the following features. The code list value help may include a list of codes each representing code list value help for an item at the user interface. The code list value help may include a code header, a code value, and a code description. The cache may be implemented in memory rather than in a persistent repository, wherein the cache include a plurality of code lists each including a code header, a code value, and a code description. The plurality of code lists may be replicated from a persistent repository into the cache to enable access to the plurality of code lists by the code list provider accessing the cache. The code lists may be selected for replication from a persistent repository based on a switch table.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts a block diagram of a system for providing value help including a code list;

FIGS. 2A-B depicts a user interface including code list value help;

FIG. 3 depicts another block diagram of a system for providing value help including a code list;

FIG. 4 depicts a process for providing code list value help; and

FIG. 5 depicts tables storing code list information.

Like labels are used to refer to same or similar items in the drawings.

### DETAILED DESCRIPTION

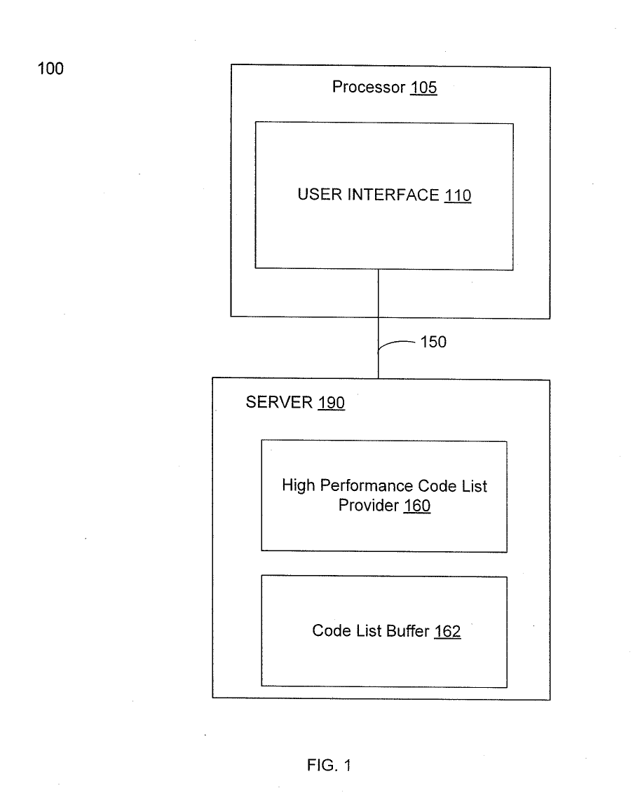

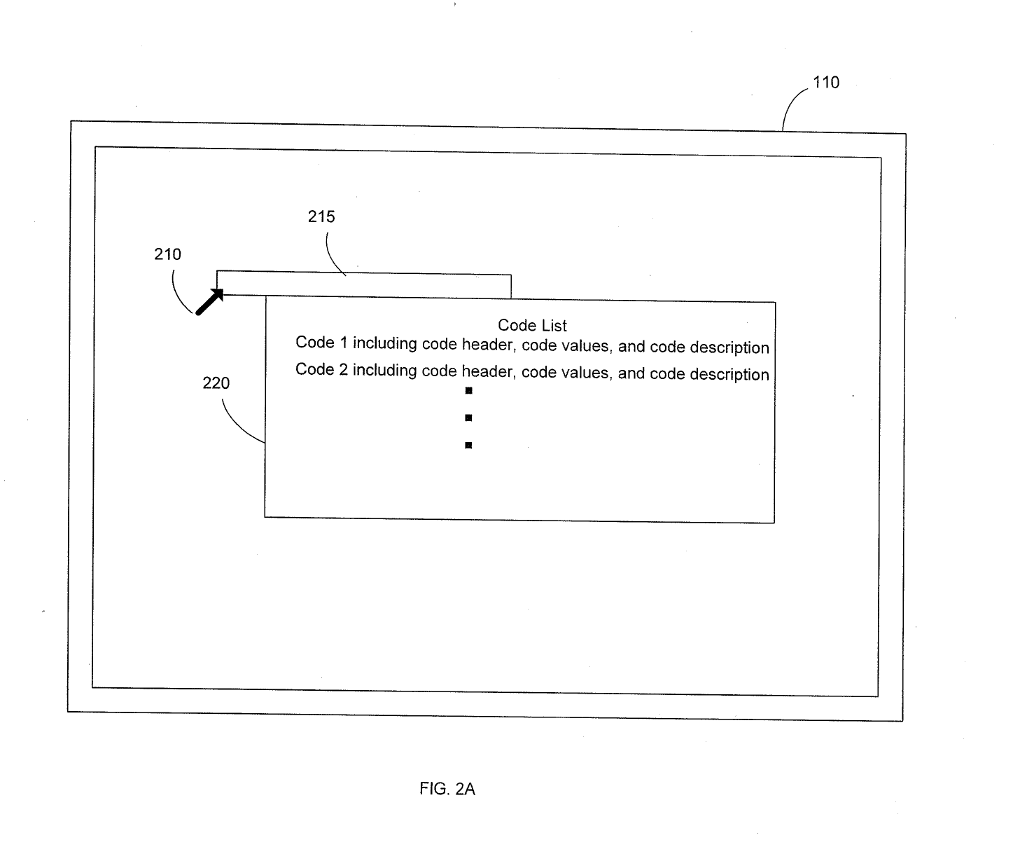

FIG. 1 depicts a system 100 including a processor 105 and a server 190, which are coupled by a network 150. The processor 105 further includes a user interface 110. Server 190 further includes a code list provider 160 (labeled high performance code list provider) and a code list buffer 162.

The processor 105 may be implemented as any processor capable of executing an application, such as user interface 110, and the like. For example, the processor 105 may include at least one processor, such as a central processing unit, and at least one memory (which may include code and/or data). Examples of processor 105 include a computer, a computing device, a tablet computer, a mobile wireless device, a blade server, or any other suitable processing device.

The user interface 110 may be implemented as any type of interface that enables interaction with aspects of system 100, including server 190, code list provider 160, and code list buffer 162. For example, user interface 110 may be implemented as a web browser (which may include one or more plug-ins), a client application, a thin client, and any other interface mechanism.

The network 150 may be any type of wired and/or wireless mechanism and may include, alone or in any suitable combination, the Internet, a telephony-based network, a local area network (LAN), a wide area network (WAN), a dedicated intranets, wireless LAN, an intranet, a public land mobile network, a wireless network, a bus, and/or any other communication path.

The server 190 may include at least one processor and at least one memory (which may include code and/or data). The at least one memory may be implemented as any type of storage mechanism including random access memory, read only memory, FLASH memory, and/or any other mechanism for storing data. The server 190 may be implemented as one or more of the following: a computing device, a computer, a processor, a blade server, or any other suitable processing device.

The server 190 may execute one or more applications, such as code list provider 160. Code list provider 160 may generate a code list (e.g., a list of code) and provide the code list to a user interface, such as user interface 110. Moreover, the code list provider 160 may provide the code list as part of a value help function at user interface 110. For example, a user may move an indicator over an element of user interface 110, and value help may present, either autonomously or when selected (e.g., selecting F4), a code list as value help for that element of user interface 110.

The code list buffer 162 may provide code list information to enable the code list provider 160 to provide value help including the code list. In some implementations, the code list buffer 162 stores the code list(s) in a database and/or table. Furthermore, the stored code lists may be buffered in memory, such as readily accessible random access memory, dynamic RAM, and the like, rather than store the code list in slower, longer-term, persistent storage, such as a hard drive and the like. In some implementations, the stored code lists are stored using tables specific to a client (e.g., a tenant) and in tables that are common to clients.

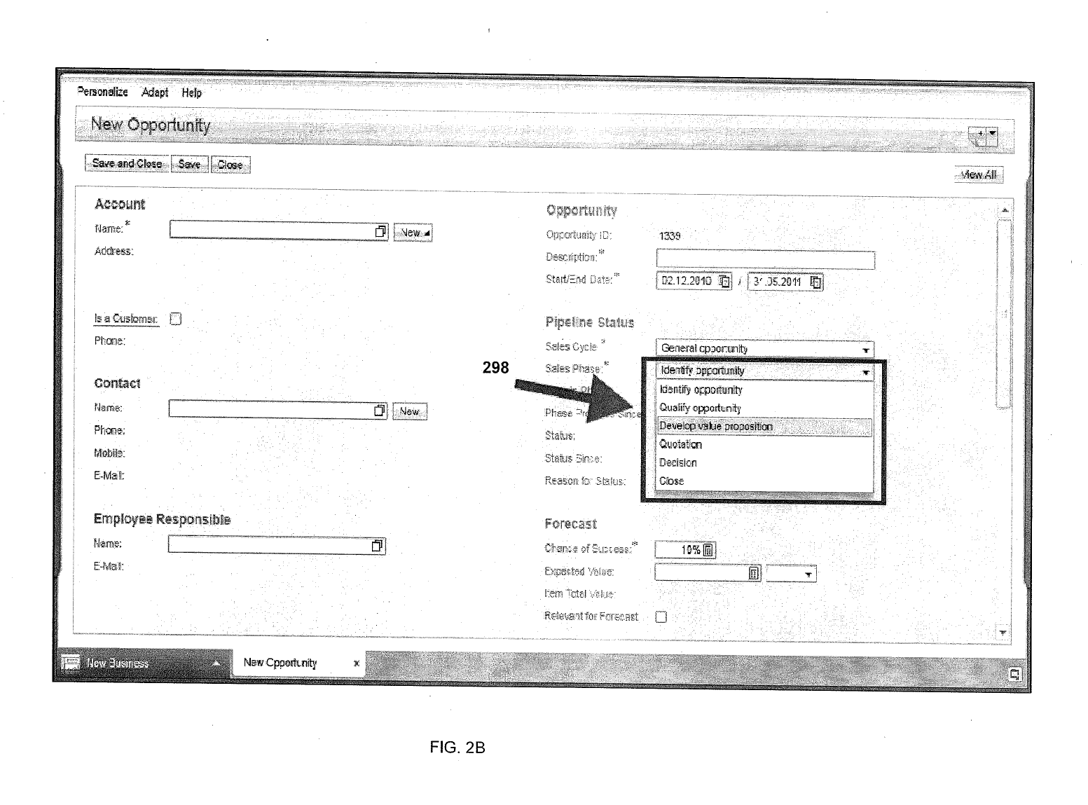

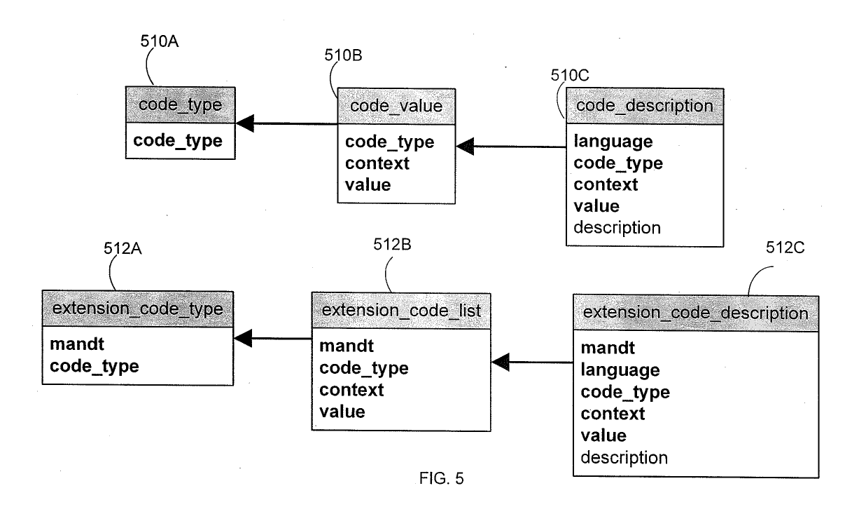

FIG. 2A depicts an example implementation of a page presented at user interface 110. Specifically, FIG. 2A depicts an indicator 210 pointing at an input element 215, and value help including a code list 220 being presented. The code list 220 includes a code header, code values, and code description. The code header refers to a description of the type of code. The code values refer to code values of the code lists and contexts in the code type table. The code description refers to a general description of the code. Examples of the code header, code value, and code description are provided below with respect to FIG. 5.

To further illustrate the code header, code values, and code description, suppose there is a “document status code,” which can have the values 1, 2, 3 with the semantics of 1 being equated to new, 2 being equated to released, and 3 being equated to obsolete. Then, the code header would include a code type value to represent these codes. For example, a code type 42 may be configured to correspond to a code value table having 3 entries for this code type: 42 1; 42 2; and 42 3. The semantics for these 3 entries are as follows: 42 1 “document status code—new;” 42 2 “document status code—released;” and 42 3 “document status code—obsolete.” The code descriptions may be language dependent and implemented as follows: 42 1 EN new; 42 1 DE neu; 42 2 EN released; 42 2 DE freigegeben; 42 3 EN obsolete; and 42 3 DE obsolete, wherein “EN” corresponds to English and “DE” corresponds to German. In some implementations, a duplicate, second set of tables (which have similar semantics) may be used to add an additional key column to allow client-specific codes or code variations.

Referring again to FIG. 2A, code 1 and/or code 2 may be selected by the user (e.g., a developer) to enable the user to use the selected code at input element 215. For example, the user may be configuring a system, such as a database, application, enterprise resource planning system, and the like. In this example, the user may be customizing the configuration of the system by selecting one or more pieces of data or code, such as with code 1 and/or code 2. Thus, the code list 220 is provided to the user when completing that task. For example, the above-noted example for code type 42 may be implemented as a drop down box to allow a user to select the status of a document. FIG. 2B depicts another example of a code list in a drop down box 298 including code-based help for the sales phase.

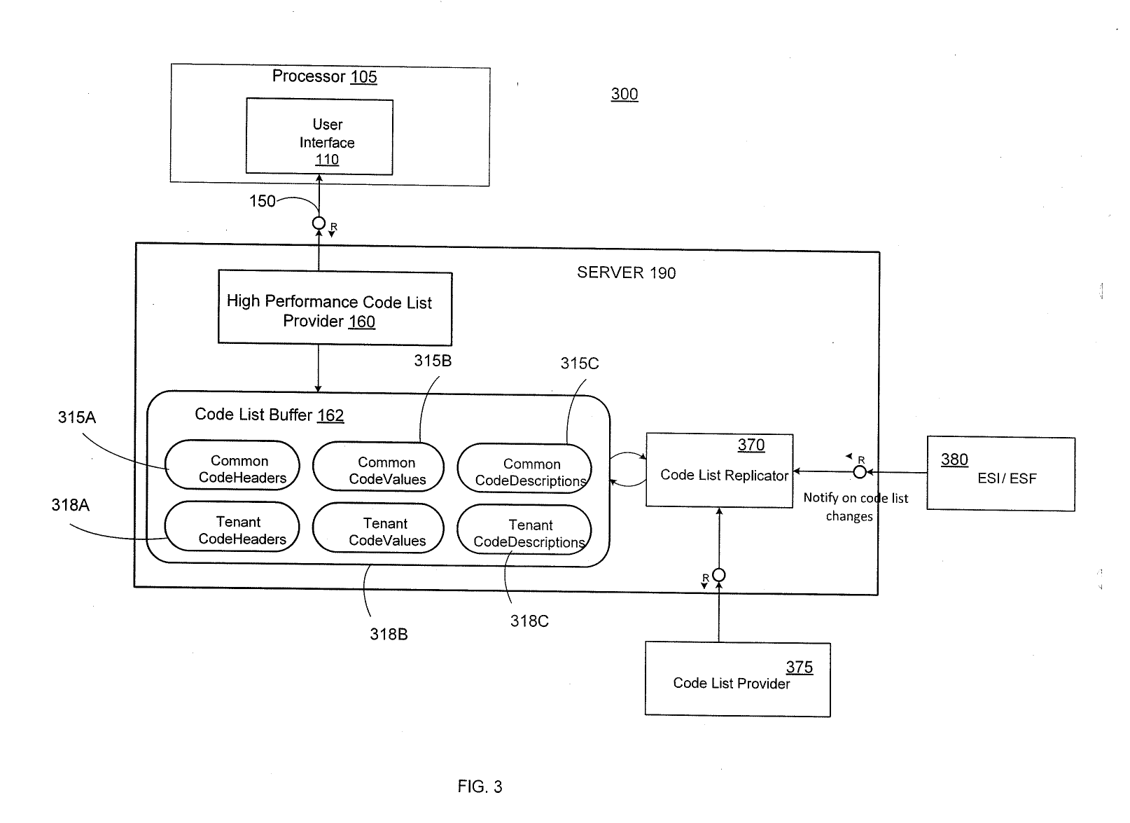

FIG. 3 depicts a system 300 for providing a code list as part of value help function. System 300 includes some of the elements of system 100. However, system 300 depicts the code list buffer 162 including tables, such as common code header 315A, common code values 315B, and common code descriptions 315C, tenant code header 318A, tenant code values 318B, and tenant code descriptions 318C, all of which are described further below. System 300 also includes a code list replicator 370 for copying code lists into buffer 162, and a code list provider 375 for providing code lists not available at code list buffer 162.

In some implementations, a majority of the code lists required for the user interface 110 are stored in memory in the code list buffer 162, and the remainder are accessed via code list provider 375.

In implementations where the remainder is accessed via code list provider 375, the code list buffer 162 includes some, but not all, of the code lists which may be provided to user interface 110 as part of value help. When this is the case, the code lists not available at code list buffer 162 are provided by code list provider 375 (which obtains the missing code list information from a persistent repository). For example, code lists may accessed via code list provider 375 rather than code list provider 160, when one or more of the following occurs: the code list requires conversion, the code that is too long (which takes up a large amount of memory), the code list has a long key value, and the code list has a long description.

Furthermore, in some implementations, about 85 or 90 percent of the code lists required for user interface 110 are stored in memory in the code list buffer 162, although other percentages may be stored in code list buffer 162 as well.

In some implementations, code lists that are shared by a plurality of users (also referred to as tenants) are stored in tables 315A-C. For example, common code header tables 315A may include a description of the code type; common code values 315B may include to code values of the code lists and contexts in the code type; and common code descriptions 315C may include a description of the code. Furthermore, code lists that are specific to a given user (or tenant) are stored in tables 318A-C. For example, tenant code header tables 318A may include a description of the code type; tenant code values 318B may include code values of the code lists and contexts in the code type; and tenant code descriptions 318C may include a description of the code.

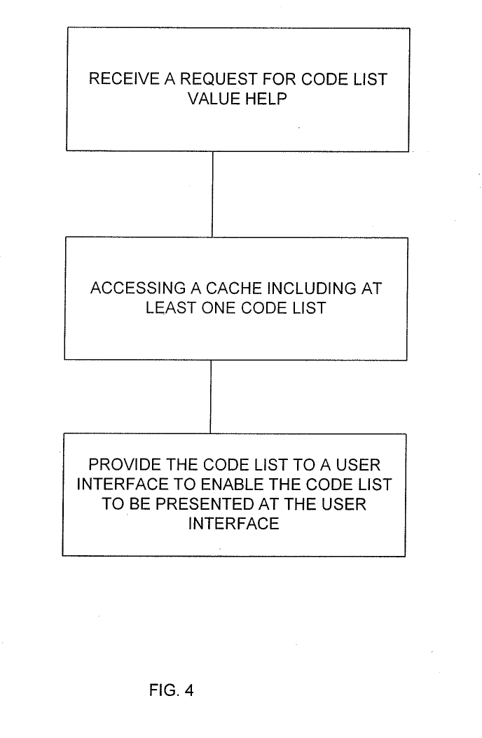

FIG. 4 depicts a process 400 for providing value help including a code list.

At 410, a value help request is received for a code list. For example, code list provider 160 may receive a request for value help including a code list (also referred to herein as “code list value help”). The request may be received as a message indicating which of the plurality of elements at user interface requires the code list value help. For example, a first element at the user interface may have a first code list value help and a second element at the user interface may have a second code list value help. Consequently, the request includes an indication of whether the value help is for the first element or the second element.

At 420, cache is accessed to obtain the code list value help. For example, the code list provider 160 may access code list buffer 162 including tables 315A-C and 318A-C to obtain information to form the code lists. For example, the tables 315A-C and 318A-C may store information, which can be formed into the code list, or the tables 315A-C, and 318A-C may store the actual tables. In any case, the code list buffer 162 provides to code list provider 160 the code lists used as code list value help. In some instances, the code list is not available at code list buffer 160. When this is the case, code list provider 160 may access code list provider 375 to obtain the code list from persistent storage. The use of in memory tables 315A-C and 318A-C may provide, in some implementations, rapid code list value help, when compared to accessing code list provider 375.

At 430, the code list is provided to a user interface, so that the code list is presented as value help at the user interface. For example, the code list provider 160 may send the code list to user interface 110, wherein the code list is presented as value help for an element of the user interface 110 as depicted at FIG. 2.

FIG. 5 depicts an example implementation of tables containing code list information stored at code list buffer 162. The common code header table 315A may have the form of table 510A. The common code value table 315B may have the form of table 510B. The common code description table 315C may have the form of table 510C.

The code_type table 510A may include a list of all supported code types and code lists. The key to table 510A may be an internal, short name of the code list, and, as noted above, the table 510A may be buffered in memory at code list buffer 162. The excluded flag indicates if a code is to be excluded from the code list value help mechanism, although the default is typically to include the code in the code list value help mechanisms described herein. In some implementations, the code list provider 160 may include a mechanism for programmatically adding or deleting code from the code list at code list buffer 162. For example, if the tables in buffer 162 become full, or approach a threshold, a code may be excluded using the exclude flag at table 510A from the code list stored at buffer 162. In this example, the excluded code may be stored in another storage device and accessed via code list provider 375.

The code value table 510B includes all code values of all code lists and contexts in the code type table. The table 510B may be buffered at 162 with one or more key fields. The disabled field (which is included in table 510B) indicates that a code value is disabled, i.e., the code value may be still be used for presentation and query purposed but not entered as a value anymore. To illustrate by an example, suppose it is Germany in the year 1990 and the local currency is the “Deutsche Mark” but today in 2010 the local currency is the Euro. In this example, the respective code values are DEM and EUR. However suppose an old invoice from 1990 is presented at a user interface, the currency code will be DEM and its description must be in the system to enable presentation of the currency, but for the DEM, the disable field would be set (i.e., no one must be able to select DEM as a value for a any new document but the system must be able to select DEM when needed).

The code description table 510C includes descriptions of some, if not all, of the code values. The table 510 may be buffered at 162 with one or more key fields (e.g., three key fields). The code description table 510C contains the disabled field to avoid retrieval of that field from the value table 510B.

The code description table 510C also includes a language field, which is the first key field. Using the language field as a key field may be realized as the language filed is very stable during a user session, and the language filed does not typically change among users (e.g., most users will log in to a given system using a common language). Hence, the language field was placed before the key list to ensure that the language field will be subject to the buffer 162.

In some implementations, the tables 510A-C are replicated with an additional key field for tenant specific settings. Tenant specific settings are specific to a given client or user while common settings are shared among most, if not all, tenants of a system. For example, the tenant code header tables 318A may have the form of table 512A. The tenant code value table 318B may have the form of table 512B. The tenant code description table 318C may have the form of table 518C. For example, code list provider may lookup whether the extension code type table 512A at buffer 162 includes an entry for a desired code for a code list. If so, the tenant specific tables are accessed, otherwise the generic tables 510A-C are accessed to find the desired code.

In some implementations, the extensibility of code lists may be controlled using a switch table framework. This approach would include a lookup to determine whether a corresponding switch for a code is active and then using the “active” information to determine where to retrieve the codes.

The code list data may be replicated from a persistent repository into memory at code list buffer 162 including tables 315A-C and 318A-C. If there are any changes to the underlying code list information, the changes may be replicated to buffer 162. Thus, any changes to the data are replicate when a change is made (e.g., upgrades, transports, deployment, etc). For example, the framework (labeled ESI/ESF) 380 may provide to the code list replicator 370 notifications of any changes to the underlying code list information caused by a change. In some implementations, the code list replicator 370 detects whether code lists are not suitable for replication and excludes them from replication. For example, a code list having too many entries or too much content (which exceeds a predefined limit in buffer 162) might be excluded from replication into the buffer 162. If a code list was previously replicated and then requires exclusion, the code list provider 160 may delete the obsolete code list entries in buffer 162.

In some implementations, tenant specific tables and common tables (which are independent of any given client) are selected during replication by code list replicator 370 in accordance with the switches noted above. For example, a client dependent table, T1, is generated, such as Table 1 below, and a client independent table, T2, is generated, such as Table 2 below. These tables are used to determine whether a given client, such as client 001 is provided a code list.

TABLE 1
Client dependent Table T1

| Client | Code |
|---|---|
| 0001 | 1 |
| | 2 |
| 0002 | 1 |
| | 2 |
| 0003 | 1 |
| | 2 |
| 0003 | 3 |

TABLE 2
Client independent Table T2

| Code | Switch |
|---|---|
| 1 | initial |
| 2 | Initial |
| 3 | switch A |

In the examples of Tables T1 and T2, switch A is active only for client 003. Thus, client 001 and client 002 would be provided with code 1 and code 2, and client 003 would be provided with code lists 1, 2, and 3. In this example, a single switch table, TS, may also be implemented as depicted below at Table 3.

TABLE 3
Switch Table,TS

| Client | Switch |
|---|---|
| 003 | Switch A |
| 003 | |
| 002 | |
| 001 | |

The switch table, TS, enables client specific filtering. Referring again to the above example using the code type 42, suppose a customer wants to include an additional code, so the codes would be as depicted at Table 4. The new tenant specific code, 42 4 “document status code—ready for review,” is not be visible to other tenants (or customers), so a tenant specific extension is used to isolate the client specific code, 42 4, to a given client. The use of a switch table, such as Table 3, may also save memory when compared to replicating the codes at each client table.

TABLE 4
Code list including client independent and
client dependent values

42 1 “document status code—new”
42 2 “document status code—released”
42 3 “document status code—obsolete”
42 4 “document status code—ready for review”

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Furthermore, the phrases “based on” and “based on at least” are used interchangeably herein as both phrases are equivalent. Moreover, although the above description makes references to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A computer-readable medium containing instructions to configure a processor to perform a method, the method comprising:
receiving, at a code list provider, a request from a user interface for code list value help;
accessing, by the code list provider, a cache including at least one code list, the cache implemented in memory; and
sending, by the code list provider, the at least one code list accessed from cache to a user interface to enable the user interface to provide code list value help based on at least one code list.

2. The computer-readable medium of claim 1, wherein the cache is implemented in memory rather than in a persistent repository, and wherein the code list provider comprises at least one processor.

3. The computer-readable medium of claim 2, wherein the code list value help comprises a code header, a code value, and a code description.

4. The computer-readable medium of claim 1, wherein the code list value help comprises a list of codes each representing value help for an item at the user interface, and wherein the cache includes a plurality of code lists each including a code header, a code value, and a code description.

5. The computer-readable medium of claim 1, further comprising:
replicating a plurality of code lists from a persistent repository into the cache to enable access to the plurality of code lists by the code list provider accessing the cache.

6. The computer-readable medium of claim 5, further comprising:
selecting at least one of the code lists based on a switch table.

7. A computer-implemented method comprising:
receiving, at a code list provider, a request from a user interface for code list value help;
accessing, by the code list provider, a cache including at least one code list, the cache implemented in memory; and
sending, by the code list provider, the at least one code list accessed from cache to a user interface to enable the user interface to provide code list value help based on at least one code list.

8. The computer-implemented method of claim 7, wherein the code list value help comprises a list of codes each representing value help for an item at the user interface, and wherein the code list provider comprises at least one processor.

9. The computer-implemented method of claim 8, wherein the code list value help comprises a code header, a code value, and a code description.

10. The computer-implemented method of claim 7, wherein the cache is implemented in memory rather than in a persistent repository, and wherein the cache includes a plurality of code lists each including a code header, a code value, and a code description.

11. The computer-implemented method of claim 7, further comprising:
replicating a plurality of code lists from a persistent repository into the cache to enable access to the plurality of code lists by the code list provider accessing the cache.

12. The computer-implemented method of claim 11, further comprising:
selecting at least one of the code lists based on a switch table.

13. A system comprising:
at least one processor; and
at least one memory configured to provide operations comprising:
receiving, at a code list provider, a request from a user interface for code list value help;
accessing, by the code list provider, a cache including at least one code list, the cache implemented in memory; and
sending, by the code list provider, the at least one code list accessed from cache to a user interface to enable the user interface to provide code list value help based on at least one code list.

14. The system of claim 13, wherein the code list value help comprises a list of codes each representing value help for an item at the user interface.

15. The system of claim 14, wherein the code list value help comprises a code header, a code value, and a code description.

16. The system of claim 13, wherein the cache is implemented in memory rather than in a persistent repository, and wherein the cache includes a plurality of code lists each including a code header, a code value, and a code description.

17. The system of claim 13, further comprising:
replicating a plurality of code lists from a persistent repository into the cache to enable access to the plurality of code lists by the code list provider accessing the cache.

18. The system of claim 14, further comprising:
selecting at least one of the code lists based on a switch table.
